(19) United States
(12) Patent Application Publication
(10) Pub. No.: US 2017/0334486 A1
(43) Pub. Date: Nov. 23, 2017

(54) TRACTOR WITH MOVABLE MUDGUARD DEVICE

(71) Applicant: SAME DEUTZ-FAHR ITALIA S.p.A., Treviglio, Bergamo (IT)

(72) Inventors: Alessandro PLEBANI, Treviglio, Bergamo (IT); Luca CAMPAGNA, Treviglio, Bergamo (IT)

(21) Appl. No.: 15/526,606

(22) PCT Filed: Oct. 21, 2015
(86) PCT No.: PCT/IB2015/058121

§ 371 Date: May 12, 2017

(30) Foreign Application Priority Data
Nov. 12, 2014 (IT) BG2014A000048

(51) Int. Cl. B62D 25/16; B62D 25/18; B62D 49/06

(52) U.S. Cl. CPC B62D 25/168; B62D 49/06; B62D 25/182; B62D 25/163; B62D 25/161

(57) ABSTRACT

A tractor (1) has a mudguard device (5) including a cover element (50) suitable to surround at least along an arc of circumference the respective wheel assembly (100) and suitable to act as a separation element along a transverse axis (Y-Y) between the respective wheel assembly (100) and an operating area (200) containing components of the tractor (1). A support system (51) is suitable to attach the cover element (50) to the respective axle (10). The cover element (50) can be guided in movement from a covering position in which the cover element covers the respective wheel assembly (100) to an open position in which the operating area (200) is accessible, and vice versa.

### FIELD OF APPLICATION

The present invention relates to a tractor comprising a mudguard device fitted with components such as to allow a guided positioning of the mudguard from an open position to a closed position.

In the following description, the term “tractor” shall refer to both agricultural tractors, and more generally, the earth moving machines derived from agricultural tractors.

### STATE OF THE ART

A typical purpose of mudguards in vehicles, and in particular in tractors, is to surround the respective wheel assembly so as to prevent elements from the soil or lying on the road, such as mud, sand, stones, liquids, from being projected into the air by the wheel assembly and in particular by the tyre. In other words the mudguard must protect the user of the tractor, the external environment surrounding the tractor, and the vehicle itself from eventual accidents caused by this eventuality.

The solutions of the prior art provide for tractors comprising fixed mudguards, often an integral part of the vehicle body, for example, as regards the rear mudguards, directly included in the structure of the driving cabin of the tractor as an integral part of the cabin, in particular, projecting from it outside the enclosed area.

According to a known tractor embodiment, the mudguard surrounds the wheel assembly along a partial arc of circumference but does not protect the inside of the vehicle. In other words, if an operating area is defined inside the tractor, containing tractor components, such as for example parts of the braking system or of the hydraulic system, this is accessible for the performance of servicing operations, but is not properly protected. In this embodiment therefore said working area is usually particularly dirty inasmuch as not protected by the mudguard and therefore subject to be struck by the splashes and mud moved by the tyre.

In further known tractor embodiments, the mudguard is a more complex shape, such as to also shelter the aforesaid operating area of the tractor; in particular the mudguard also extends in height, between the wheel assembly and the vehicle body. However these known solutions make access to the operating area particularly difficult, thereby complicating the servicing operations of the components contained therein; for example to access the operating area the servicing technician is obliged to dismantle and remove the mudguard of the tractor.

### Presentation of the Invention

The object of the present invention is to make a tractor with a mudguard device such as to fully meet the purposes set forth, overcoming however the aforementioned problems of the prior art.

Such object is achieved by a tractor made according to claim 1 and by the movement method according to claim 12. The dependent claims describe further preferred embodiments.

### DESCRIPTION OF THE DRAWINGS

The characteristics and advantages of the tractor according to the present invention will be evident from the description given below, by way of a non-limiting example, according to the appended drawings, wherein:

FIG. 1 shows a side view of a tractor of the present invention, according to a preferred embodiment, fitted with a mudguard device in the closed position;

FIG. 1b shows a side view of the tractor in FIG. 1a′ in which the wheel assembly is removed and the mudguard device are still in the closed position;

FIG. 1c shows a side view of the tractor in FIG. 1b in which the mudguard device is in an open position;

FIGS. 2a and 2b show two front side views, without the wheel assembly, of the axle and the mudguard device, respectively in a closed position and in an open position according to a preferred embodiment;

FIG. 3 shows a rear perspective view of the mudguard device and of a portion of axle according to a preferred embodiment;

FIG. 4 is an orthogonal view from the bottom of the mudguard device and of the respective tractor axle, according to a preferred embodiment.

### DETAILED DESCRIPTION

With reference to the appended drawings, reference numeral 1 globally denotes a tractor. In a non-limiting manner the figures show a tractor 1 of the agricultural tractor.

The tractor 1 has a longitudinal axis X-X, along the direction of advancement of the tractor in a straight line, a transversal axis Y-Y perpendicular to the longitudinal axis X-X and parallel to the axles 10 on which the wheels assemblies 100 comprised in the tractor 1 are mounted, and a vertical axis Z-Z, perpendicular to the longitudinal axis X-X and to the transversal axis Y-Y.

The tractor 1 comprises a driving area for the user, preferably composed of a driving cabin 2 housable by the user; moreover, the tractor 1 identifies a rear axle 11 and a front axle 12.

According to a preferred embodiment, the tractor 1 comprises a mudguard device 5. Preferably the mudguard device 5 is placed on the rear axle 11, which extends below the cabin 2.

According to a preferred embodiment, the mudguard device 5 comprises a cover element 50 suitable to surround the respective wheel assembly 100 along at least an arc of circumference. The mudguard device 5 is also suitable to act as a separation element along the transversal axis Y-Y between the wheel assembly 100 and an operating area 200 containing components of the tractor 1 requiring the performance of maintenance operations. In other words, the inside of the tractor 1, and the components contained within it, are generally defined as operating area 200.

In fact, focusing on the rear axle 11, the tractor 1 has said operating area 200 substantially in a position in the rear end, for example between the wheel assemblies 100 of the rear axle 11. For example, said operating area 200 comprises a portion, of the braking system of the tractor and/or a portion of the hydraulic system of the tractor and/or one or more valves for the compressed air system of the tractor and/or diesel filters of the fuel supply system of the engine of the tractor and/or parts of the electrical system of the tractor.

In a preferred embodiment, the operating area 200 is located substantially below the driving cabin 2; consequently the operating area 200 is suitable to contain a plurality of functional components relevant to the cabin 2, such as the relative shock absorber system.

According to a preferred embodiment, the cover element has a radial portion 50 suitable to extend radially with a tapered pattern near the axle 10; in other words, said radial portion 501 is substantially the shape of a circular sector.

According to a preferred embodiment, the cover element 50, at the outer end of the radial portion 501, has an arched portion 502 shaped in such a way as to cover at the top, by a predefined arc of circumference, the wheel comprised in the respective wheel assembly 100.

Preferably, the cover element 50 is made of a single piece, for example of plastic, for example in a single mould. In further embodiments, the cover element 50 is made of several parts.

Preferably, the cover element 50 comprises components relative to the electric system such as those of the rear lighting; in other words, the rear lights are housed in the cover element 50.

According to a preferred embodiment, the mudguard device 5 further comprises a support system 51 suitable to support the cover element 50.

Preferably, the support system 51 comprises an attachment element 510 for attaching the mudguard device 5 to the respective axle 10.

Preferably, the attachment element 510 is integrally connected to the axle 10 preferably by means of attachment brackets integrally connected to it, for example by means of specific screws and bolts.

According to a preferred embodiment, the attachment element 510 comprises a flanged body 511 suitable to extend radially from the axle 10. Preferably said attachment element 510 has a circular sector shape, similarly to the radial portion 501.

According to a preferred embodiment, the cover element 50 can be guided in movement from a covering position in which it covers the respective wheel assembly 100 to an open position in which it makes the operating area 200 accessible, and vice versa.

In other words, the cover element 50 is movable relative to the axle 10 and to the support system 51.

According to a preferred embodiment, the covering element 50 is positionable as needed in at least a closed position, and at least an open position, in other words the cover element 50 is positionable in a plurality of open positions, for example to allow more or less easy access to some portions of the operating area 200.

According to a preferred embodiment, the movement between the two positions of the cover element 50 takes place in a planar manner. For example, preferably, the cover element 50 is guided in movement by a rotary movement or roto-translatory or translatory movement. In other words, defining an imaginary plane perpendicular to the longitudinal axis X-X and to the transversal axis Y-Y, the cover element 50 is substantially suitable to maintain a portion thereof, for example the radial portion 501, always lying on said imaginary plane.

Preferably, the support system 51 comprises guide elements 515 suitable to guide the movement of the cover element 50.

According to a preferred embodiment, the guide elements 515 are suitable to guide the cover element 50 in movement according to a rotatory trajectory around a rotation axis R-R.

Preferably, said rotation axis R-R is the axis along which the respective axle 10 extends, which is thus, preferably, parallel to the transversal axis Y-Y.

For example, the cover element 50 is suitable to be guided in rotation by an arc of about 45°.

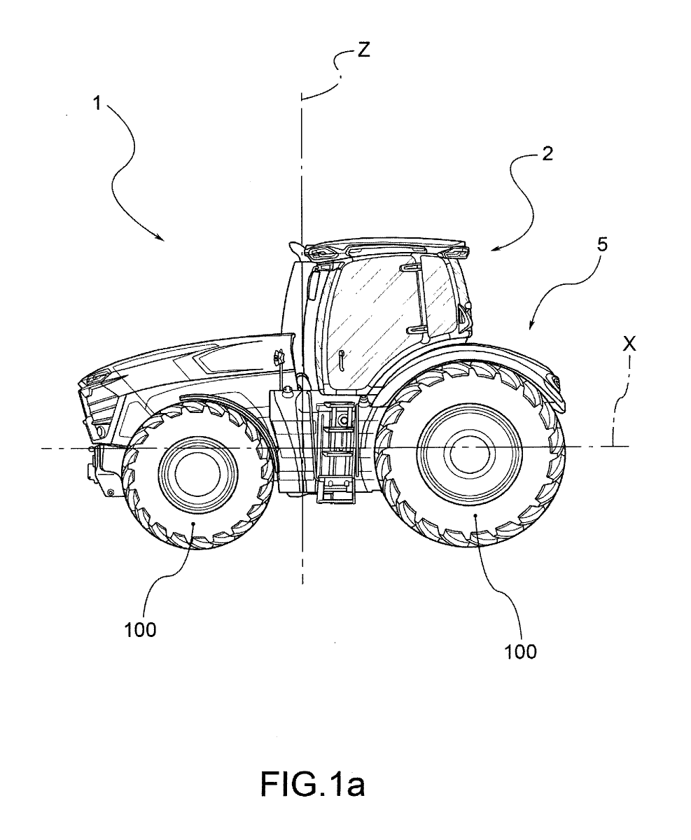

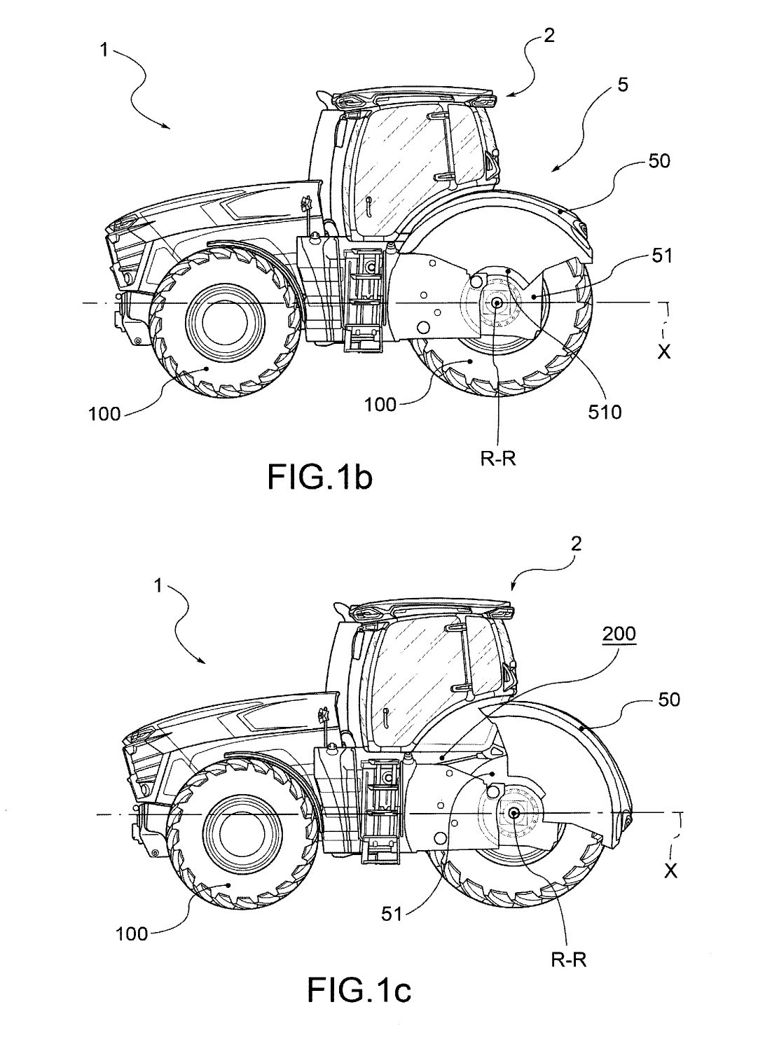

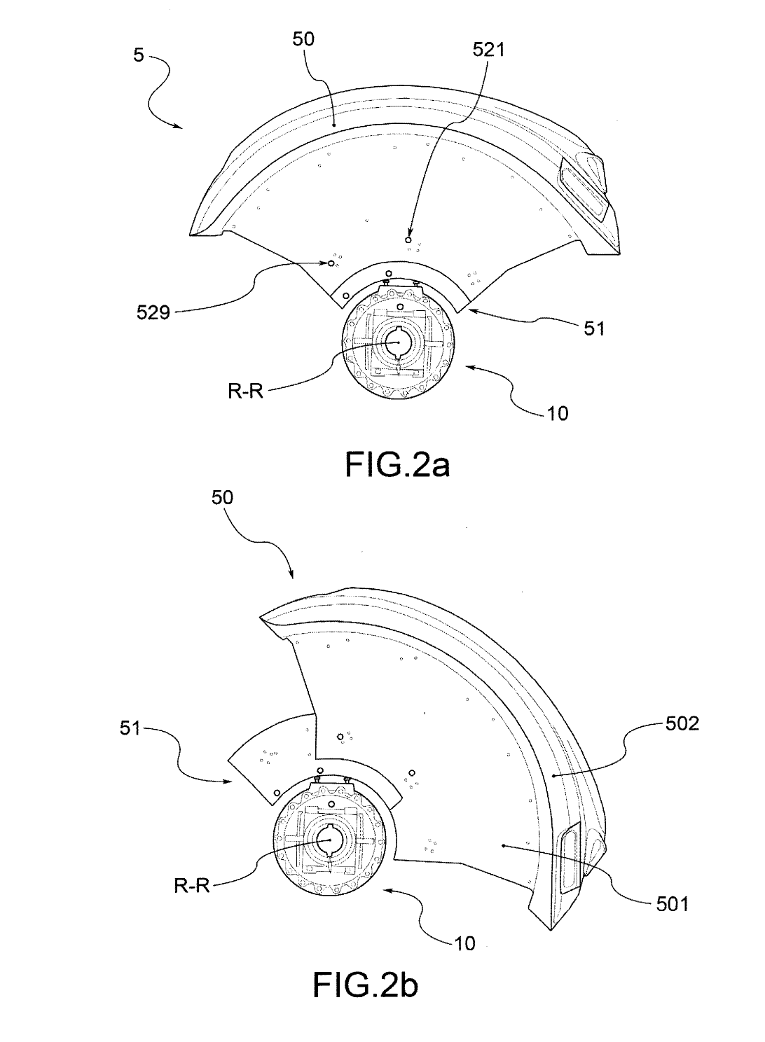

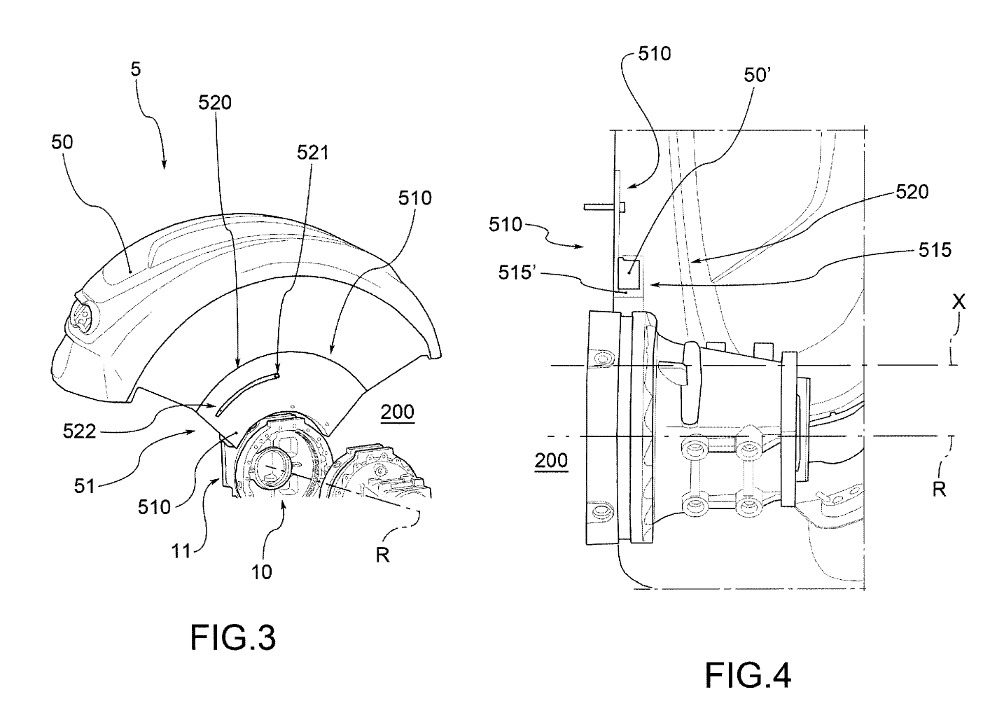

Preferably, with respect to the drive direction along the longitudinal axis X-X, the cover element 50 is suitable to be guided in rotation in the direction opposite to said drive direction. In other words, for example in the attached FIGS. 1a, 1b and 1c the rotation of the cover element 50 around the rotation axis R-R is clockwise.

According to a preferred embodiment, the guide elements 515 are made on the flanged body 511 or integrally connected to it.

In other words, the guide elements 515 comprise a guide rail 515′ in which the cover element 50 is suitable to slide when guided in movement. According to a preferred embodiment, said guide rail 515′ is made in a position proximal to the axle 10.

Preferably, in said embodiment the cover element 50 comprises rollers 50′ suitable to facilitate the sliding of the cover element inside the guide rail 515′.

According to a preferred embodiment, the rail 515′ has an arched trajectory along a predefined arc of circumference.

Preferably, the ends of the rail 515′ correspond angularly with the closed position and the open position.

According to a preferred embodiment, the guide elements 515 are also suitable to perform the function of keeping the cover element 50 in the direction of the transversal axis X-X. For example, the rail 515′ has substantially a C-shape such as to contain and retain the cover element 50 which it acts in conjunction with.

According to a preferred embodiment, the mudguard device 5 further comprises stop means 520 designed to stop and/or lock in the closed position and/or in the open position the movement of the cover element 50 in relation to the attachment element 510.

In other words, the stop means 520 are suitable to constitute end stroke elements to the guided movement of the cover element 50.

Preferably, the stop means 520 comprise an insertion pin 521, preferably made on the cover element 50, and a stop guide 522, preferably made on the attachment element 510, suitable to interact with each other to achieve the end stop positions of the movement of the cover element 50 in relation to the attachment element 510.

As shown for example in the attached figures, the insertion pin 521 is made projecting from the cover element 50, on the radial portion thereof and is suitable to be housed in the stop guide 522, in such a way that the movement of the cover element corresponds to a sliding of the insertion pin 521 inside the stop guide 522.

Preferably, the ends of the stop guide 522 correspond angularly with the closed position and the open position.

According to a preferred embodiment, the stop means comprise a security insert 529 acting in conjunction with the cover element 50 and with the attachment element 510 to prevent the reciprocal movement thereof. Preferably, the security insert 529 is a pin or a screw or rivet or similar and is suitable to cross the cover 50 and the attachment element 510 transversally.

The security insert 529, is thus suitable to integrally lock the cover element 50 to the attachment element 510, preferably when the cover element 50 is placed in the closed position and the tractor 1 is ready to move.

In some preferred embodiments, the movement of the cover element 50 is of the manual type 50.

According to a preferred embodiment, the mudguard device 5 comprises means for moving the cover element (not shown) suitable to move the cover element 50 between the closed position and the open position. Preferably said movement means may be electrically or mechanically or hydraulically or pneumatically powered.

In a preferred embodiment, said movement means may be cushioned.

According to a preferred embodiment, the driving cabin 2 comprised in the tractor 1 and the mudguard device 5, described above, are separated from each other. In other words, the driving cabin 2 and the mudguard device 5 are, in a preferred embodiment, structurally separated, so that there are no reciprocal interactions with each other.

Preferably therefore, in relation to the load-bearing frame of the tractor 1, including the axles 10, the driving cabin 2 is a sprung mass while the mudguard device 5 is a non-sprung mass. In other words the driving cabin 2 is connected to the rear axle 11 free to move with respect thereto, being connected by means of specific cushioning means, for example air springs. The mudguard device 5 instead is directly connected to the axle 11 by mean of the support system 51 not by means of air springs or other cushioning systems.

Preferably, the cabin 2 is distanced from the mudguard device 5, preferably from the cover element 50, along the transversal axis Y-Y.

The present invention also relates to a method of moving a mudguard device 5 of a tractor 1 having the characteristics described above, comprising the step of moving the cover element 50 in relation to the attachment element 510 from a closed position in which it covers the respective wheel assembly 100 to an open position in which it makes the operating area 200 accessible, and vice versa.

In accordance with the method of moving a mudguard device 5 as above, a method of servicing a tractor is also described, comprising the steps of:
removing the wheel assembly 100 of the tractor 1;
moving the cover element 50 of the mudguard device 5 to access the operating area 200.

Innovatively, the tractor of the present invention permits the achievement of the purpose of the invention, i.e. to provide a tractor with a mudguard suitable to protect the user of the tractor, the environment surrounding the tractor and the tractor itself from the launch of material caused by the tyre, all while providing easy access and maintenance of the operating area.

Advantageously, the tractor has an operating area which is protected from mud, dirt and liquids projected by the tyre.

In addition, advantageously, the tractor has an accessible working area without having to dismantle the mudguard.

A further beneficial aspect lies in the fact that, in the servicing operations of the operating area, all the components, for example electric, fitted on-board the mudguard need not be dismantled in turn.

A further advantageous aspect of the tractor of the present invention is that the mudguard and the driving cabin do not have reciprocal interactions.

Advantageously, therefore, the dynamic behaviour of the driving cabin is not influenced by the mudguards. In other words, the cushioning performance of the driving cabin is improved. In other words, the driving cabin has limited vibrations.

Advantageously, the tractor has smaller maximum dimensions than the same tractor with a mudguard fixed to the driving cabin. In other words, the mudguard is configurable according to the different types of tyres fitted, while the design of the driving cabin is not affected by the different sizes of different tyres, reason for which it is positioned at a lower height.

Advantageously, the driving cabin of the tractor is positionable at a height to the order of a few centimetres, for example 5 cm below the tractors of the prior art. Advantageously, the tractor offers particular benefits in terms of ride comfort thanks to this feature.

Advantageously, the tractor also has an increase in side and rear visibility from inside the cabin; so in this sense the tractor offers increased driving safety.

A further advantage of the tractor of the present invention is also related to the drive means and/or the stop means which are designable in such a way as to provide feedback on the movement of the cover element so as to stop and/or block it in specific end stop positions, preventing possible accidents related to the movement of the cover element.

In further embodiments of the tractor 1, according to the present invention, the guiding of the induced movement of the cover element 50 may be subject to further changes, for example the guide elements may comprise slide systems, quadrilateral or pantograph systems or the like.

It is clear that a person skilled in the art may make modifications to the tractor and to the mudguard device described above so as to satisfy contingent requirements, all contained within the scope of protection defined by the following claims.

1. Tractor having a longitudinal axis and a transversal axis parallel to which axles extend, on which respective wheel assemblies are mounted, and a mudguard device comprising:
a cover element suitable to surround at least along an arc of circumference the respective wheel assembly and suitable to act as a separation element along the transversal axis between the wheel assembly and an operating area containing components of the tractor;
a support system suitable to support the cover element and comprising an attachment element for attaching the mudguard device to the respective axle;
wherein the cover element is guidable in motion from a covering position in which the cover element covers the respective wheel assembly to an open position in which the cover element makes the operating area accessible, and from the open position to the covering position.

2. Tractor according to claim 1, wherein the attachment element comprises a flanged body extending radially from the axle.

3. Tractor according to claim 1, wherein the support system comprises guide elements suitable for guiding in motion the cover element.

4. Tractor according to claim 3, wherein the guide elements are suitable to guide in motion the cover element according to a rotatory trajectory around a rotation axis parallel to the transversal axis.

5. Tractor according to claim 3, wherein the attachment element comprises a flanged body and the guide elements are made on the flanged body or integrally connected to the flanged body.

6. Tractor according to claim 1, wherein the mudguard device comprises a stop designed to stop and/or lock in the closed position and/or in the open position movement of the cover element in relation to the attachment element.

7. Tractor according to claim 6, wherein the stop comprises an insertion pin made on the cover element, and a stop guide, preferably made on the attachment element, suitable to interact with each other to achieve the end stop positions of in motion the cover element in relation to the attachment element.

8. Tractor according to claim 6, wherein the stop comprises a safety insert operatively connected between the cover element and attachment element to prevent reciprocal movement.

9. Tractor according to claim 1, comprising a rear axle, wherein the mudguard device is attached to the rear axle of the tractor.

10. Tractor according to claim 1, comprising a driving cabin, wherein the mudguard device and the driving cabin are separate from one another.

11. Tractor according to claim 1, wherein the mudguard device comprises means for moving the cover element suitable to move the cover element between the closed position and the open position.

12. Method of moving a mudguard device of a tractor comprising a cover element suitable to surround a respective wheel assembly along at least an arc of circumference and suitable to act as a separation element along a transversal axis between the wheel assembly and an operating area containing components of the tractor, and comprising a support system suitable to support the cover element and comprising an attachment element for the attachment of the mudguard device to the respective axle; wherein said method comprises the steps of:
moving the cover element in relation to the attachment element from a closed position in which the cover element covers the respective wheel assembly to an open position in which makes the operating area accessible, and
moving the cover element from the closed position to the open position.
